(19) United States
(12) Patent Application Publication
(10) Pub. No.: US 2016/0140860 A1
(43) Pub. Date: May 19, 2016

(54) Certification Implemented with Adult Learning Techniques

(71) Applicant: PainRx, Co., Chesterfield, VA (US)

(72) Inventors: David M. GLICK, Midlothian, VA (US); Barbara KORNBLAU, Arlington, VA (US)

(21) Appl. No.: 14/541,171

(22) Filed: Nov. 14, 2014

(51) Int. Cl. G09B 9/00; G09B 19/00

(52) U.S. Cl. CPC G09B 9/00; G09B 19/00

(57) ABSTRACT

An interactive software tool is used to obtain informed acceptance of compliance criteria. The subject is presented with a series of instructional formats in the form of a series of instructional scenarios. These instructional scenarios require concept-based interpretive activity to demonstrate an understanding of the compliance criterion. If the subject responds incorrectly, a subsequent scenario is presented that demonstrates a second application of the compliance criterion. If the subject fails to demonstrate his/her understanding after the second scenario, a flag is triggered. This flag alerts the prescriber or pharmacy to personally engage with the individual to help him/her understand and comprehend the subject matter, which the individual to failed to understand. This prompts engagement and interaction with the patient that might not otherwise occur. Upon completion of the active response at a predetermined level of accuracy, an indication of successful comprehension or understanding of the relevant concepts is provided.

### BACKGROUND

1. Field

This subject matter relates to implementation of adult learning methods to teach, inform, explain verify and certify understanding and comprehension of critical patient information associated with the use of medications, medical devices, and the patient's compliance with the teaching process.

2. Background

Certain medical procedures, such as the administration of pain relief drugs have a significant potential for misuse, as well as intentional and unintentional abuse, and diversion that require specific understanding on the part of the patient. In most cases, the patients' proper use of these medications is necessary to optimize and maintain clinical efficacy. Moreover, it is often the responsibility of the physician or other medical care provider to provide adequate instruction to the patient regarding proper use and avoidance of actions which circumvent the intent of the prescription, compromise patient safety and maintain clinical efficacy.

While some forms of misuse or abuse can be intentionally reckless, there are other activities which could be in contravention of the prescription, but which can seem to be insignificant to the patient. In addition, some activities can have significant implications for the use and/or abuse of the pain relief or other drugs. By way of example, some patients mistakenly believe “if some medication is good, more is better.” This can lead to incorrect dosing which may adversely affect the patient and could result in death. In the absence of proper medical advice and instructions, if patients take medication, it can result in additional risks to the patient, including death. Such considerations even apply to over-the-counter medications, such as the non-steroidal anti-inflammatory class, which had had a notable fatality rate as well as other well-known complications.

There is a great potential for misapplication and abuse of particular types of prescription pharmaceuticals. These can include medications with a Risk Evaluation and Mitigation Strategy (REMS) program established under the U.S. Food and Drug Administration Amendments Act of 2007, or those medications that require a significant amount of patient knowledge, compliance, and education. In the case of opioids for example, the misapplication of pain relief drugs has harmed patients and member of the general public, as evidenced by a strong correlation between opioid prescriptions and opioid overdose death. While it can be expected that some of the mortality results from prescription errors, it is clear that a significant factor is patient error or misuse. Moreover, while misuse or abuse of prescribed items such as pharmaceuticals can often be attributed to a conscious decision to abuse the prescribed items, the high mortality and addiction rate of opioid pain relief drugs suggests that these issues exceed what would be expected from intentional abuse of the drugs. This also suggests that misuse in part results from either the patient misunderstanding dosing instructions or not appreciating the risks and responsibilities involved in not following the prescription.

There are classes of medications that could benefit from teaching, informing, and explaining through principles of adult learning so that patients use the medication properly, avoid misusing the medication, and improve their health and mitigate any potential harm. For example, common medication prescribed for attention-deficit disorder, is sometimes misused and abused, which could result in harm or even death. In another example, opioids used for pain relief carry a high potential for abuse and addiction. The potential for abuse of opioids used for pain treatment has historically been a significant problem. Opioids provide a pleasurable effect and are considered to be a classic example of addictive drugs. In part this relates to the property of binding to the opioid receptors in the brain and spinal cord, where opioids cause the subjective effects, which can encourage addiction. When used for pain relief, tolerance for the drug can be developed; however, the dose required to achieve analgesia can level off for many months at a time. The combination of the pleasurable effect and the effect on pain can encourage the patient to increase the dosage, which can potentially compromise the medical efficacy. Physicians and other prescribers are encouraged, and in some cases required to strictly adhere to the instructions for the use of these, and other medications to maximize clinical efficacy and balance the risks associated with their use. For example, with the use of opioids, there is a strong tendency for patients to associate the subjective effects of opioids with the actual effect on pain, which provides an incentive to increase use of the drug.

Addictive substance abuse can be mitigated by avoiding engaging in “risky behavior” such as, for example by avoiding consumption of illegal drugs associated with addiction. Despite this, the use of opioid pain relievers for their intended purpose historically has proven a type of risky behavior to the extent that it leads to abuse and other adverse outcomes. Risky behaviors with opioids and other potentially abusive medications also can be inadvertent or unintended. Storing one's medication where others may find it and use it or sell it inadvertently encourages criminal acts and is a known problem. Even storing medications in containers other than those in which they were originally dispensed can lead to inadvertent or mistaken use of legitimate prescribed medication. Taking a medication for a purpose other than the reason for which it was prescribed is also considered inappropriate aberrant behavior. There are even occasions where with good intentions, the person for whom the medication was prescribed, offers the medication to a friend or family member with a seemingly similar problem. Though done with good intentions, there is significant potential for danger in sharing legally prescribed medications and, while it is illegal; the degree of criminal culpability will depend on the medication in question.

Existing procedures are aimed at reducing abuse and diversion of prescription drugs, most of which take the form policing the problem. The existing programs are not focused on insuring that patients are competent and engaged in understanding and using their prescription medications and medical devices.

Education and certification for addictive pain relievers such as opioids is given by way of non-limiting example. In addition to drugs having an addictive potential, there are a number of drugs which carry a high degree of risk for other reasons. As a further non-limiting example, insulin has a high potential for fatal overdose (insulin shock) for which the patient must be educated in proper dosing techniques.

Patients may take multiple medications, which may interact with each other. Their physicians may not be aware of the other medications that other providers have prescribed for them. For example, in the case of a patient under pain management, multiple drug use may or may not be under the supervision of a single physician, physicians' practice group or health care provider group. Patients must play an active role in insuring that their prescribing health care providers are aware of all the medications they take. This concept is reinforced in the patient engagement adult learning tool.

In order to maximize safety, the health care provider must see to it that the patient is fully instructed in the use of medications subject to misuse and abuse. This includes following precautions established by the health care provider, such as controlling the source of prescribed medications, as well as following detailed instructions regarding the self-administration of the medications. Such instructions are often misunderstood or not entirely remembered by the patient for various reasons. Therefore, even if a patient desires to comply with precautions, compliance is not always achieved. There are considerations found in the implementation of procedures which are intended to allow the health care provider to enforce restrictions in the use of medications. Such procedures include use of a single dispensing pharmacy and bringing pills in for “pill counts”. These procedures are not seen as directly related to patient compliance and in some cases are viewed as a representing lack of trust.

More significantly, while such restrictions as not sharing medications and increasing dosages are easily understood, restrictions and procedures which are not directly related to following the prescription are not always easily remembered by patients. Patients take a variety of medications and require instruction on how to take their medications. Current practice includes demonstration, giving the patient handouts such as medication package inserts, and in the case of opioids medication, signing “patient-prescriber agreements”. These methods detail the relevant considerations, instructions, safety information and responsibilities important for the use of their particular medications. While these efforts are intended to insure individual patients understand how to properly take their medications, none of the current methods insure that the patient actually understands the relevant factors necessary for their medications. In fact, many patients report they did not understand what they read, remember what the provider told them or showed them, and often do not recall receiving a patient handout or signing an opioid agreement.

### SUMMARY

Informed acceptance of compliance by an individual is achieved in a series of subject based scenarios, which require interactive responses. A set of compliance criteria is prepared. A selection of subject-based scenarios is presented that incorporate multiple aspects of adult learning theory. This process maximizes the subject individuals' potentials to incorporate and demonstrate an understanding the subject matter. After presenting the subject individual with the respective subject matter, the subject individual is presented with respective scenarios that require an interactive response. The interactive responses require subject individual perform interpretive activity for each subject and identify features of each subject to verify whether the subject individual had met the compliance criteria. The subject individual must meet the compliance criteria using through at least one method of adult learning theory, including, but not limited to, listening to or reading and individual one of the series of subject matter concept scenarios, or demonstrating an understanding the compliance criterion expressed by each individual one of the series of subject matter concepts. If an incorrect response is received, the subject individual is notified of the incorrect response and a subsequent scenario is presented in the form of an alternate scenario to offer a second opportunity become understand and apply the subject matter. If the subject responds incorrectly, a subsequent scenario is presented that demonstrates a second application of the compliance criterion. If the subject fails to demonstrate his/her understanding after the second scenario, a flag is triggered. This flag alerts the prescriber or pharmacy to personally engage with the individual to help him/her understand and comprehend the subject matter, which the individual to failed to understand. This prompts engagement and interaction with the patient that might not otherwise occur. Upon completion of the active response at a predetermined level of accuracy, an indication of successful comprehension or understanding of the relevant concepts is provided.

### BRIEF DESCRIPTION OF THE DRAWINGS

FIG. 1 is a flow diagram showing the functions and purposes of the program.

FIG. 2 is a flow diagram showing an example of a concept and question sequence of an interactive assessment tool.

### DETAILED DESCRIPTION

Overview

There are many programs in the country aimed at reducing abuse and diversion of prescription drugs. Most take the form policing the problem; however, none of them rely on insuring that patients are competent and engaged in understanding and using their prescription medications and medical devices.

The disclosed subject matter uses a program which, for the first time, provides a unique public health prevention-based approach to ensure proper use and care of prescription drugs and medical devices, rather than the current and proposed punitive approaches. With regard to medications that have a high tendency for abuse or misuse, this is the first program of its kind that insures patients' competence and engagement in understanding the medication they take and the medical devices they use. This program aims to improve patient care and safety and reduce the abuse and diversion of prescription drugs. Thus, instead of policing the problem as warranting a punitive approach, this program educates and informs patients of the inherent risks, benefits, and responsibilities of prescription drugs and medical devices, thereby engaging patients in their own health care outcomes and decisions while shifting a portion of responsibility to the patients.

As opposed to previous techniques, the disclosed approach insures patients' competence and engagement in understanding and using the prescription medications they take and medical devices they use. The program is also significant because multiple prescribers, and health care providers, as well as pharmacists and/or insurers can use it. The results can be placed in the electronic medical record, which through meaningful use, can be shared with other providers. A mechanism or technique also can be implemented to make the information available to state prescription drug monitoring programs (PDMPs).

The present disclosure relates to a patient engagement adult learning tool for medication management enhancing safety and efficacy. The tool, called “HealthQ²”, uses principles of adult learning to teach patients how to use and manage their medication(s) safely and legally, store their medication(s), and comply with applicable laws regarding their medication(s). The same methods can be applies to the use of therapeutic medical devices. It is designed to insure patients have learned and understand the information presented. Online electronic interactions may involve avatars of authority figures explaining the subject matter using multiple principles of adult learning. Following the subject based scenarios, patients demonstrate their understanding of the subject concept. The tool is designed to ensure informed risk-benefit decisions before initiating treatment, insure patients understand appropriate use of their medicines, and mitigate the risk of misuse, abuse, addiction, overdose, and serious complications due to medication errors through patient engagement.

By using an interactive, real-time internet-based multimedia tool encompassing principles of adult learning theory and health literacy principle, patients are presented with information specific to the medication the user is prescribed, followed by an interactive assessment that verifies the knowledge, skills, and competence the user has acquired. Once the interactive assessment verifies the knowledge, skills, and competence the user has acquired, a certificate of completion issued. This tool insures that patients understand the need for all of their physicians to know about all of the medications they take.

As indicated above, the interactive assessment is used to provide a certificate of completion, which demonstrates knowledge and awareness of required patient protocols for self-administration of regulated pharmaceuticals such as certain opioids, and other medications where a Risk Evaluation and Mitigation Strategy (REMS) program and/or significant instruction is necessary to insure proper use, such as diabetes medications, or anticoagulants. Prescribers, pharmacies, and third party payers may choose to require the certificate of completion before writing or refilling a prescription. Significantly, the certificate of completion demonstrates that the patient has been properly instructed and demonstrates that they are aware and understand the proper use of the prescribed product and the restrictions regarding the product, the product referred to a medication or medical device.

By using an interactive, real-time internet-based multimedia tool encompassing principles of adult learning theory and health literacy principles, patients are presented with information specific to the medication or device the user is prescribed, followed by an interactive assessment that verifies the knowledge, skills, and competence the user has acquired. This tool provides the patient with information at a level that the patient can understand and verifies through the processes described that the patient can understand and apply the information. This equips patients so they can engage in their own health care, and it empowers and enables them to make decisions regarding their own health and health care with regard to their prescribed medication. More importantly, it helps insure individual patients understand the importance of proper use of medications and compliance with laws, policies, and procedures associated with the use of their medications. This will help both maintain medical efficacy and contribute to patient safety, as well as the safety of others. Once the interactive assessment verifies the knowledge, skills, and competence the user has acquired, the patient is presumed to have been informed, and a certificate of completion issued.

During a session with the interactive assessment tool, information is presented on screen, and read by a different authority figure character or avatar relevant to the subject matter of each screen. The character's animated avatar typically appears on the screen, speaking directly to the user. At the conclusion, the character's presentation of the concept or subject, the user is presented with an opportunity to respond to a scenario based on a situation to verify that the user understood the information and/or concept, essentially applying the learned information. If correct, the user proceeds to the next topic (concept or subject). If the user has not been able to validate their understanding of the concept or subject, the user is presented with the same concept in a different form and another situation to which the user must apply their knowledge in order to proceed further. This may include additional information to facilitate learning and to further clarify the concept or subject matter. If at any time the concept or subject is still not validated, a certificate of competition is not issued and a flag is generated that requires human intervention by a relevant health care provider. The relevant health care providers will be informed of their patients' lack of understanding of that concept(s) or subject(s) so they may personally engage their patients, and insure the patients' understanding of the relevant subject matter.

As a patient engagement tool, the technique implements patient engagement concepts to patients using multiple, overlapping principles of adult learning and patient engagement often via an avatar that represents a competent authority figure related to the subject presented. When appropriate, the avatars may be culturally competent. Adult learning techniques include interactive learning, in which the student response is used for clarification of the concepts taught, reinforcement of this knowledge by either implementation or by scenarios that require an interactive response. The scenarios that require an interactive response represents another form of adult learning theory, a psychomotor guided response. This can include a question and evaluation of the response. If the student shows difficulty with the implementation or content of their response, according to adult learning techniques, the student is again instructed in the concept and is again engaged with either interaction or responses.

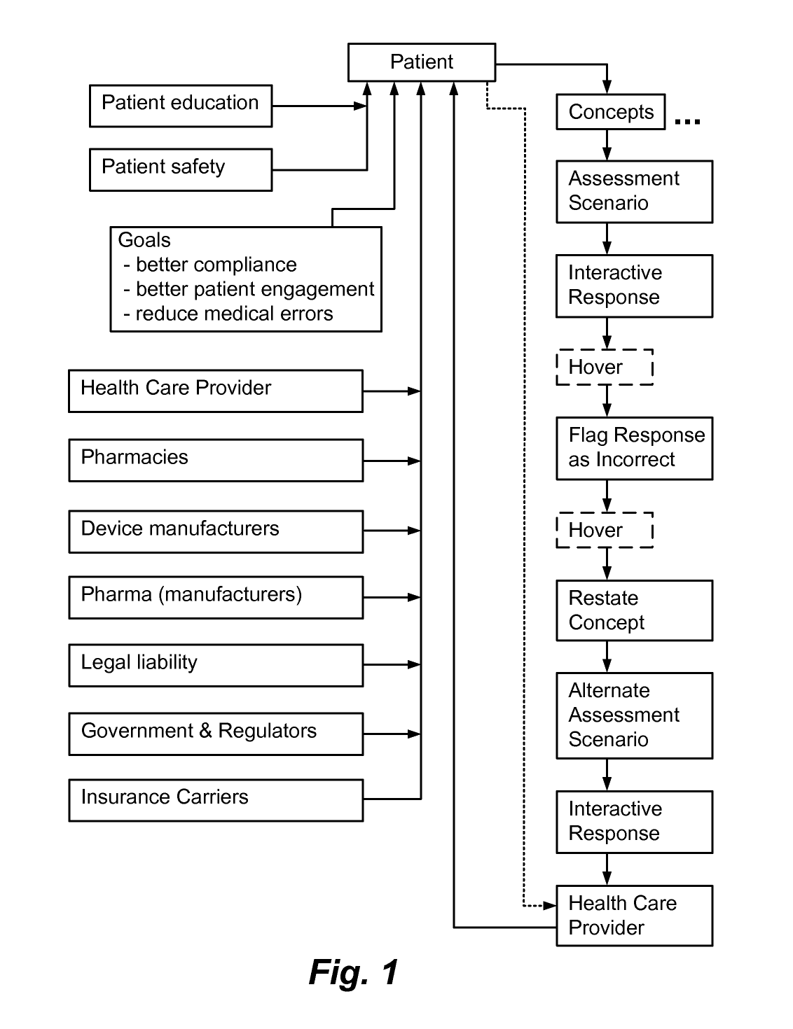

FIG. 1 is a flow diagram showing the functions and purposes of the program. In general, the purpose is to provide education and safety for the patient. In part, the education and safety is achieved externally from the program, for example by diagnostics, ordinary instruction and prescription control. The interactive assessment tool is used to augment this with respect to providing the patient with the patient education and safety. The purposes include goals of better compliance with prescription requirements, better patient engagement and reduced medical errors. A number of different interests and considerations are involved, including those of the health care provider, pharmacies, suppliers, those interested in reducing potential harm, including those bearing legal liability, government and regulators, and medical insurance carriers.

To address these requirements, the patient is asked to review specific concepts intended to address the above purposes. The interactive assessment tool generally approaches each concept by the use of adult learning concepts, including:

1. acquiring knowledge or memorized facts;

2. organizing knowledge as understanding memorized facts; and

3. applying the knowledge.

In the case of the interactive assessment tool, the acquisition of knowledge includes brief instructions and scenarios. Organizing the knowledge is achieved through the instructions and scenarios which may provide explanatory material, and in the use of scenarios requiring basic analysis of the knowledge during application of the knowledge. The application of the knowledge is achieved in analyzing the scenarios and selecting the correct responses. Each of the steps of “acquiring,” “organizing” and “applying” occur throughout the implementation of the interactive assessment tool. Nevertheless, the steps of “acquiring”, “organizing” and “applying” are emphasized in respective parts of the interactive assessment tool.

The multiple, overlapping principles of adult learning and patient engagement insure maximal comprehension and understanding of the concepts presented. Patients are presented with interactive scenarios. The primary purpose is to educate the patient sufficiently to reduce the risks involved in the use of pharmaceuticals subject to significant abuse, such as is the case with opioids used for pain relief purposes.

Adult Learning Procedure and Principles of Adult Learning

Learning can be defined in many ways. For the purpose of this disclosure, learning can be considered reinforcement of a concept or an action that leads to change in or enforcement of behaviors of the learner as a result of gaining knowledge or skills through and experience or practice.

Learning Theory is a body of principles advocated by educators and physiologists to explain how people acquire skills, knowledge and attitudes. Learning Theory involves of consideration of cognition, the process of learning and thinking, inclusive of knowing, perceiving, problem solving, decision making, awareness, and related intellectual activities.

One of the shortcomings with human behavior as it relates to the brain processing information is that the brain (the mental process) is constantly bombarded with inputs from all senses. In computer terms this could be equivalent to millions of bits of information. In order to deal with the amount of information being processed at any point in time, the brain allows much of the information that is considered habitual to go unnoticed or ignored. As a result, routine or more mundane instruction sets may be deemed not to be a priority. It is the purpose of this interactive teaching tool to prioritize the concepts that are deemed essential to proper use and handling of medications a patient may be prescribed so as to maximize clinical efficacy and minimize the risk associated with aberrant, addictive or even potentially criminal behaviors, in the case of controlled substances such as opioids.

Basic application of this tool involves the application of Higher Order Thinking Skills (HOTS), which includes problems based learning, authentic problems, real world problems, patient centered learning, active learning and comparative learning, which can be altered or enhanced to meet the patient's needs. It is believed that most learning comes from perception of stimuli. To enhance the potential for learning, each patient is essentially stimulated on several levels to help support comprehension of subject or concept. They are presented with images, are given the opportunity to both read and listen to the content, and asked to apply concepts of active learning require a content based response, which require the use of psychomotor skills, further reinforcing their gained knowledge, awareness and understanding of the concept. Technically, while memorization is possible, by applying real world scenarios, and building upon complexities, concept learning and understand should be enhanced.

It is presumed that different learning styles will be effective for different patients, and different patients will have and different preferences for learning styles. Examples of learning styles include:
Active—retain information by doing something,
Reflective—prefers to think about information quietly,
Sensing—learning of facts,
Intuitive—discovering possibilities and relationships,
Visual—remembering what is seen,
Verbal—learning from written and spoken explanations,
Sequential—learns best by step by step explanations, or
Global—learning by comprehending large bits of information.

Multiple styles are applied so as to enhance the likelihood of the patient to learn and understand each of the concepts deemed appropriate for their proper use of the medication (clinical efficacy) and responsibility of handing such medications, including aberrant, abusive or criminal behaviors.

Adult learning is a form of concept learning involving interactive exchange. The tool is premised on concept learning. Concept learning assumes humans tend to group things that share common attributes that set those concepts apart. By grouping information into concepts, humans create manageable discrete categories. Instead of describing one thing, concepts describe several important features at once. For example:
“Take your medication as your health care provider tells you at certain prescribed intervals”
   embodies several concepts in one.

This form of learning is a three-step process.

1. Learners are exposed to new information.

2. Learners organize the information and new knowledge they learn.

3. Learners apply the new knowledge to solve problem and make decisions.

As applied to the tool, the learners are patients. The tool enables patients to apply what they learn. Patients learn by doing. They apply problem-solving tactics to realistic scenarios. These scenarios resemble the actual environment and actual dilemmas to which they will apply their newly acquired knowledge and skills as part of their own medication “journey”.

The interactive, online patient engagement tool is designed with “how adults learn” as its focus. It incorporates multiple principles of adult learning and principles of health literacy in its design.

According to principles of adult learning, most people learn visually with auditory and kinesthetic learning playing an important role. The online, interactive, patient engagement tool incorporates all three vehicles for learning. Visual Learners have an opportunity to “see” the information via avatars, charts, and graphs and the written word. Auditory Learners hear the content specific concepts presented to them. Kinesthetic Learners use their sense of touch to use hover buttons on the computer as part of the learning process to demonstrate their understanding of concepts.

The principles of adult learning recognize that adults bring prior learning and experience to the learning process and the following:
Learning is facilitated by the learners' involvement in their own learning experience.
Adults are practical
Adult learners like to be respected
Adult learners want relevant information
Adults are goal oriented
Adults are self-directed

Principles of health literacy are incorporated into the learning tool, and include:
Using examples
Using plain language
Speaking clearly
Using a post-test to evaluate patients' understanding
Focusing on behavior change
Using short sentences
Using written communication that looks easy to read
Including visuals as part of instruction
Presenting important information first

The learning methods are implemented by presenting patients or other learners with interactive content that demonstrates or highlights each individual key concept, or learning objective. An avatar, which may represent a culturally competent authority figure related to the subject, presents some of the key concepts or learning objectives to patients Immediately following presentation of each key concept or learning objective, patients apply what they have learned to scenario-based questions. This enables user to demonstrate an understanding of each concept/learning objective—one concept at a time, to build a cumulative understanding of the subject matter.

Incorrect responses trigger a review of the concept/objective presented in a different manner, and a subsequent scenario is presented; with a second opportunity to demonstrate understand of the compliance criterion. Following the second presentation or review of the concept, the patient is given a second chance to apply the concept to a second scenario-based problem on that concept.

The second incorrect response triggers a flag to call to the attentions of the prescriber or pharmacy to personally engage the individual to insure understanding and comprehension of the subject which the individual to failed to understand. This prompts an interaction with the patient that might not otherwise occur, and the prescriber or pharmacist is then able to review that concept/objective(s) with the patient personally. The flag advises the prescriber or pharmacist to engage the patient in a one-on-one review of the specific concept(s) to insure the patient understands the concept(s).

When patients complete the online interactive learning tool, they receive a certificate of completion that can be maintained in the patient record. Patients must achieve 100% to acquire the certificate. Failure to complete the interactive learning tool successfully will trigger an alert to his/her HCP or pharmacist identifying content requiring personal engagement. Patients receive a certificate of completion and by way of non-limiting example, can review or repeat the interactive teaching tool, within a year without a new fee. The health care provider, pharmacist and others deemed appropriate are alerted to the completion of the interactive teaching tool, and can search the stored certificate to insure patients have been compliant in completion the tool for the medication class specified.

Metadata obtained from the learning tool can be analyzed and used to improve the subject matter content and format of the interactive learning tool; identify subjects and learning objectives patients find more difficult to comprehend; and improve the experience for patients as well as provider education and awareness.

Overview of Interactive Program

Patient identification initially will rely on name, birthdate and Zip code; however, this mode of identification has limitations that may still cause occasional misidentification. It is therefore anticipated that further identification, such as (by way on non-limiting example) biometric forms of identification or another standard will be used when these become available. In addition, Near Field Communication (NFC) payment systems, EMV payment systems and other secure payment systems may be used for identification, and have the further advantage of facilitating payment, if required. At that time the patient is informed of information use and a record of initial consent or non-consent for disclosure of personal information is made.

In operation, prescribers, pharmacies, and/or a third party payers pay a fee for each patient's entry into the program. The payment may be, by way of non-limiting example, performed by purchasing a subscription block for entry for a specified number of patients. Prescribers, pharmacies, and/or third party payers create an electronic key or token code, such as a quick response code (QR code), or a similar code. Prescribers, pharmacies, and/or third party payers invite patients to enter the program by giving them the code via email, text, or other electronic means, or in the form of a paper document. Patients can complete the program on the electronic device (smart phone, tablet or computer) upon which they received their invitation or on another device. Alternatively, patients can also enter the interactive learning tool, (also referred to as the “program”) by themselves, without a code and pay for their own entry into the program. Patients log on to the program using their code or they create their own code when they log on. In the event the patient logs on without a code from a third party payer, the program will check for third-party payer authorizations and if such an authorization is found, the program will offer to apply the third party payer authorization for fee payment.

Once the patient has logged, the patient authorizes the release and sharing of pertinent medical information to the prescribing and treating health care providers, HealthQ2, and well as the patients' pharmacies, PDMPs and payers when appropriate. Upon completion of the authorization and release, the patient selects their prescriber/physician and/or preferred pharmacy from the list of registered prescribers and preregistered pharmacies, or verifies their prescriber/physician and/or preferred pharmacy. If the patient's pharmacy is not pre-registered, the patient can enter the name and name and known contact information relative to the pharmacy. The registered pharmacies can match the designated pharmacies in the “lock-in” programs, which may be required by payers or state and/or federal programs. If a third party payer (i.e., insurance company) requests an individual complete the program, that patient can select or verify their payer and enter or verify their insurance ID number in the program.

Upon registration, prescribers, pharmacies, and third party payers can log into the system and view patients linked to them and/or selected by their patients upon logging in as described above. With their proper log in credentials, prescribers, pharmacies, and third party payers can search the database of patients who completed the program.

Prescribers, pharmacies, and third party payers also can view search results that indicate their patients have completed the program for a specific class of drug or medical device, or that show a flag to indicate that their patient has not successfully completed the program. If they have not successfully completed the program, it will also indicate the need for the prescriber, pharmacy, and/or third party payer to personally engage them in instruction in the concepts they did not understand.

Patients also receive an electronic printable certificate upon completion of the program. Printed certificates of completion will contain quick response codes (QR code), or similar codes in addition to a unique identifying number to help to prevent the creation of fraudulent certificates. If a patient presents a printed certificate indicating their completion of the program, prescribers, pharmacies, and third party payers can scan the code or identifying number to search the data to confirm the results.

Since no uniform system currently exists for EMR/EHR systems to communicate data with each other, prescribers, pharmacies, and third party payers can simply scan certificates of completion into the patient record. Automatic reporting can also be provided in accordance with the data provided when the patient logs-on, or as otherwise authorized. By way of non-limiting example, state Prescription Drug Monitoring Programs (PDMPs) might want access to the data to insure compliance with the state's PDMPs.

It is also contemplated that the program may be implemented through an app for certain smart phones and tablets to simplify the process. The app allows prescribers, pharmacies, and/or third party payers to create the account for the patient. The creation of the account generates an electronic invitation to the program. The app also allows prescribers, pharmacies, and/or third party payers to scan certificates, and verify completion or identify the subject matter that requires personal engagement and explanation as described above. The App could search the database for completed patient certificates, or alert prescribers, pharmacies, and/or third party payers to individuals linked to that prescriber or pharmacy.

In addition to the certificate or indication of completion of the program, upon completion of the program at a predetermined level of accuracy, the results are stored on a secure server database. The results associate associating identification information of the subject individual with said authorization. With the appropriate authorizations, the server database can then be accessed to retrieve the stored results corresponding to the completion of the active responses from the server database to allow health care providers to obtain confirmation that the patient has completed the program. The database can further store information concerning activities related to the compliance criteria, such as prescriptions obtained for relevant medications, and this information can be provided to health care providers who the patient has authorized to receive that information.

### Example

### Interactive Response

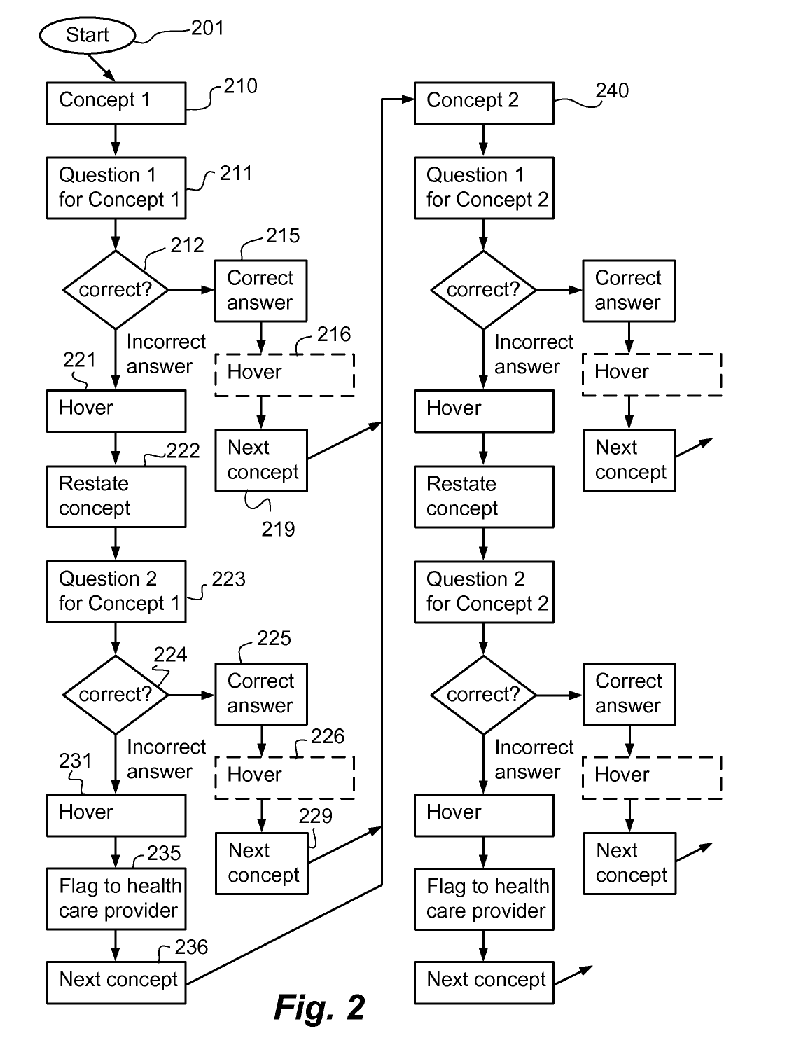

FIG. 2 is a flow diagram showing an example of a concept and question sequence of an interactive assessment tool. After starting (step 201) the session, a first concept is presented (step 220). A first assessment scenario is presented (step 211) to the patient and the patient responds. The tool determines if the response is correct (step 212), and if the response is correct (step 215), the patient has the opportunity to view an explanation of the reason the response is correct (step 216), for example by mouse hover over the question, over the correct response or over the incorrect response. Since the response is correct, the tool proceeds (step 219) to the next concept.

If the determination (step 212) is that the interactive response is incorrect, the patient is able to review the response options (step 221). The concept is restated (step 222) and a subsequent interactive response is presented for the concept (step 223) and the patient responds. A determination is made (step 224) as to whether that response is correct. As with a correct response to the first assessment scenario, if the response is correct (step 225), the patient has the opportunity to view an explanation of the reason the response is correct (step 226), for example by mouse hover over the response, over the correct response or over the incorrect response. Since the response is correct, the tool proceeds (step 229) to the next concept.

If the determination (step 222) is that the response is incorrect, the patient is able to review the response options (step 231). At this point it is presumed that the patient is not readily able to correctly response to the assessment scenario. This could be a matter of test taking skills or it could be that the patient actually does not understand that particular concept. Regardless of the reason, this becomes a fault which is flagged to the health care provider (step 235). The health care provider can then review the scenario or underlying concept with the patient and certify that the concept has been reviewed. The tool proceeds (step 236) to the next concept.

Upon proceeding to the next concept (steps 219, 229 and 236) a subsequent concept is presented (step 240), and the process repeated until all predetermined concepts are presented.

The present technique provides advantages in that scenarios are present and used as a patient engagement tool, thus providing a technique for adult learning in an environment in which interactivity is difficult to achieve. The responses to the scenarios by the patient provide both a confirmation of the patient's understanding of the concepts intended to be taught and a degree of interactivity which results in implementation of adult learning techniques. Further, since the scenarios are integrated with instruction as part of adult learning techniques, responses are applied to all concepts which are considered to be essential to the adult learning program.

Since the adult learning techniques are implemented through scenarios that require a correct response, incorrect responses are noted. Incorrect responses are flagged to the health care provider or pharmacist. In that way, the health care provider or pharmacist can review the specific flagged issue with the patient. This is more efficient because face-to-face teaching is limited to those concepts which the patient did not demonstrate competency on, which reduces time spent by the health care provider or pharmacist. This also allows the patient to learn through adult learning techniques with face-to-face instruction being focused on those concepts which the patient did not acquire through the adult learning techniques. This further allows the patient to more readily learn the concepts which require face-to-face teaching and engagement.

The tool can also identify patients who do not learn through the interactive format and may require more face-to-face instruction. This allows prescribers to spend extra time with patients, within the broader patient population, who need this personal patient engagement. Active learners who will benefit from the tool's interactive engagement format may not learn as effectively via the classic face-to-face model currently practiced and may benefit more from this tool. The patient engagement tool is designed to conform to patient-centeredness for all patients with diverse learning needs.

An incorrect response does not necessarily require review by the health care provider or pharmacist because the computerized interactive instruction will respond to the incorrect response with further instruction. If the patient provides a second incorrect response, the health care provider or pharmacist will be prompted personally review the concept with patient and provide more information to the patient and insure the patient's understanding. In that way, incorrect responses highlight concepts the patient could not comprehend. If the patients do not get a correct response to the presented concept, the patients are coached to the right response. Since the purpose of the interactive learning tool is to teach patients concepts and insure their competence in the concepts a correct response the first time around is not significant. The measure of success outcomes occurs when concepts taught are eventually learned. Successful completion of the tool is inherently motivating, since successful completion means individual patients can receive their prescribed medication to treat their conditions.

It is expected that some concepts will generate a higher than expected rate of incorrect responses. Since the incorrect response is flagged, data concerning the incorrect response can be analyzed and used to improve the scenarios and format of the interactive learning tool, and provide better feedback to patients and health care providers.

The technique uses avatars representing an authority figures typically related to the subject presents the material. This is intended to cue the patient to the purpose of the particular instruction. For example, a police figure (if suitable for the patient) would provide information regarding the legalities of sharing medications which are controlled substances, and a “white coat” avatar would provide information regarding proper dosing.

If the patient provides an incorrect response, the patient can hover over the other responses (“mouse hover”) and get an explanation as to why each response was incorrect. The explanation may be more related to the patient's interpretation of the question and answer than the understanding of basic concept, so the mouse hover will often explain that aspect of the question. More importantly, this technique also reinforces learning of the particular concept.

### Example

### Transmucosal Immediate-Release Fentanyl (TIRF) Medicines

Transmucosal Immediate Release Fentanyl (TIRF) medicines contain fentanyl, a prescription opioid pain reliever. TIRF medicines are typically used to manage breakthrough pain in adults with cancer who are routinely taking other opioid pain medicines around-the-clock for pain. The first interactive tool relating to the Transmucosal Immediate Release Fentanyl Risk Evaluation and Mitigation Strategy (TIRF REMS) program that applies to the class of medications referred to as the transmucosal opioids indicated for breakthrough cancer pain will include the following concepts:
You must take medication exactly as prescribed
You must store and dispose of medication in a particular manner
You must understand the side effects of your medication and know how to report them
You need to know when to call 911 or local emergency service
You need to inform your health care provider about certain issues that can happen when you take pain medication including:
   If your dose does not control your pain
   The appearance of side effects
   Any other medication you are taking including vitamins, dietary supplements, or over the counter medications
You may not give your medicine to others
You may not use medications not prescribed to you.
You may not stop taking your medicine without talking to your health provider
You may not break, chew, crush, dissolve, or inject your medication
You may not drink while on this medication

Interactive Engagement Format

Unlike face-to-face instruction and provider engagement alone, the interactive assessment tool provides for multiple action scenarios and determines competency by requiring a correct interactive response by the patient. This tool incorporates aspects of adult learning theory at a pace comfortable for the patient, who may otherwise feel rushed in the time limits of a typical consultation with a health care provider. This tool identifies potential concepts for which the patient cannot demonstrate adequate comprehension and understanding. By identifying these gaps in the patient's comprehension and understanding, it guides prescribers and other health care providers to the specific concepts that require greater patient engagement, thereby improving the effectiveness of provider-patient engagement.

Patients need to achieve 100% to pass or meet with their health care provider or pharmacist to review the concepts the user did not pass. Since the computerized interactive approach is designed to walk the patient through the learning process, the achievement of a “100%” score is not made difficult. If the patient is not able to demonstrate competency in one or more areas, the health care provider or pharmacist can provide the necessary level of instruction.

Patients receive a certificate of completion and log back into the interactive learning tool to review the concepts or reinforce their comprehension. Providers may request patients retake the interactive learning tool if they find the patient is noncompliant.

### CONCLUSION

Regardless of the learning style preferred by the patient, Active (retain information by doing something), Reflective (prefers to think about information quietly), Sensing (learning of facts), Intuitive (discovering possibilities and relationships), Visual (remembering what is seen), Verbal (learns from written and spoken explanations), Sequential (learns best by step by step explanations), or Global (by comprehending large bits of information), multiple styles are applied so as to enhance the likelihood of the patient to learn and understand each of the concepts deemed appropriate for their proper use of the medication (clinical efficacy) and responsibility of handing such medications, including aberrant, abusive or criminal behaviors. The same principles apply to the use of medical devices as well.

It will be understood that many additional changes in the details, materials, steps and arrangement of parts, which have been herein described and illustrated to explain the nature of the subject matter, may be made by those skilled in the art within the principle and scope of the invention as expressed in the appended claims.

What is claimed is:

1. A method for obtaining informed acceptance of compliance criteria, the method comprising:
preparing a set of compliance criteria;
offering a subject individual a choice of instruction formats and receiving a selection of an instruction format from the subject individual;
presenting the subject individual with a series of instructions, corresponding to the selection of the instruction format, directed to the compliance criteria;
after presenting the subject individual with the respective instructions, presenting the subject individual with respective scenarios that require a response, whereby the responses require interpretive activity by the subject and identify features of individual ones of the series of instructions in order to test whether the subject individual had performed at least one of the group selected from listening to or reading the individual one of the series of instructions or understands the compliance criterion expressed by the individual one of the series of instructions;
in response to an incorrect response, notifying the subject individual of the incorrect response and performing one of presenting a subsequent scenario or flagging the incorrect response by criterion associated with the incorrect response;
upon completion of the active responses at a predetermined level of accuracy, storing results corresponding to the completion of the active responses on a server database; and
providing an indication of successful comprehension or understanding of the relevant concepts as a certification criterion to provide certification.

2. The method of claim 1, further comprising:
identifying a set of principles for instruction for incorporation into instruction regarding the compliance criteria, the principles comprising:
exposure to new information, providing the information structured so that the subjects organize the information and new knowledge they learn, and using the scenarios and questions to cause the subject to apply the new knowledge to solve problem and make decisions; and
incorporating the set of principles in the instructions of each of the instruction formats.

3. The method of claim 1, further comprising, in response to an incorrect response, providing the subject individual with a review sequence.

4. The method of claim 1, further comprising, in response to an incorrect response, providing the subject individual with a sequence comprising:
informing the subject individual of the error; and
offering the subject individual a choice of an explanatory review of the topic incorrectly responded to and requesting a verbal explanation.

5. The method of claim 1, further comprising:
identifying a class of items requiring the compliance;
selecting the compliance criteria according to the identified class;
presenting the subject individual with the series of instructions as determined by the compliance criteria according to the identified class and presenting the series of test questions in accordance with the determined series of instructions.

6. The method of claim 1, further comprising:
receiving an authorization to release and share predetermined categories of pertinent medical information to predetermined categories of recipients;
associating identification information of the subject individual with said authorization;
accessing the server database to retrieve the stored results corresponding to the completion of the active responses from the server database; and
conditional on receipt of said authorization, using the accessed stored results to provide information concerning the certification criterion to the predetermined categories of recipients.

7. The method of claim 1, further comprising:
receiving an authorization to release and share predetermined categories of pertinent medical information to predetermined categories of recipients;
receiving an authorization to receive predetermined categories of received medical information from predetermined categories of information providers;
associating identification information of the subject individual with said authorization;
accessing the server database to retrieve the stored results corresponding to the completion of the active responses from the server database;
conditional on receipt of said authorization, using the accessed stored results to provide information concerning the certification criterion to the predetermined categories of recipients;
providing information to the predetermined categories of information providers an indication of the authorization to receive the predetermined categories of received medical information;
receiving, from the predetermined categories of recipients, information concerning activities related to the compliance criteria; and
providing at least a subset of the information concerning activities related to the compliance criteria to the predetermined categories of recipients.

8. The method of claim 7, further comprising:
providing at least a second subset of the information concerning activities related to the compliance criteria to recipients exempt from restrictions to access to the second subset of the information.

9. The method of claim 7, further comprising:
associating certification and the subject individual with prescription data used for dispensing restricted medications, by plural health care providers, for the subject individual;
using the prescription data to provide health care providers with information concerning the dispensed restricted medications; and
making the prescription information available to state prescription drug monitoring programs (PDMPs).
